(19) United States
(12) Patent Application Publication
(10) Pub. No.: US 2026/0075027 A1
(43) Pub. Date: Mar. 12, 2026

(54) METHOD AND APPARATUS FOR MULTIPLE USER EQUIPMENT IDENTIFIER TRANSLATION IN A WIRELESS COMMUNICATION SYSTEM

(71) Applicants: CENTRE OF EXCELLENCE IN WIRELESS TECHNOLOGY, Chennai Tamil Nadu (IN); INDIAN INSTITUTE OF TECHNOLOGY MADRAS (IIT MADRAS), Chennai Tamil Nadu (IN)

(72) Inventors: Vikram KRISHNAKUMAR, Chennai Tamil Nadu (IN); Harini Shree VELMURUGAN, Chennai Tamil Nadu (IN); Aswathy SUBRAMANIAM, Chennai Tamil Nadu (IN); Anusuya BALASUBRAMANIAN, Chennai Tamil Nadu (IN); Jeniston Deviraj Klutto MILLETH, Chennai Tamil Nadu (IN); Bhaskar RAMAMURTHI, Chennai Tamil Nadu (IN)

(21) Appl. No.: 19/285,478

(22) Filed: Jul. 30, 2025

(30) Foreign Application Priority Data
Aug. 2, 2024 (IN) 202441058644

(51) Int. Cl. H04L 61/10; H04W 8/20; H04W 48/16; H04W 64/00

(52) U.S. Cl. CPC H04L 61/10; H04W 8/20; H04W 48/16; H04W 64/00

(57) ABSTRACT

In the present application, the 5G Core Network (5G-CN) comprises various network functions (NFs) interacting with each other over a Service-Based Architecture (SBA) interface. Each NF has specific functionality and offers a set of services to other NFs. Among them, the Unified Data Repository (UDR) is responsible for storing all information related to User Equipment (UE) in a database. This storage information contains subscription data, exposure data, application data, and policy data. Another NF called the Unified Data Management (UDM) serves as the front-end interface to UDR for accessing the subscription data of the UE(s) from the database. UDM manages data for access authentication, access authorization, user registration, user identification handling and so on. Yet another NF is Network Exposure Function (NEF) that acts as a gateway for an external untrusted application function (uAF) to avail services from 5G-CN after prior authorization and authentication based on operator policies. Apart from this, it is also responsible for translation of external information from uAF to internal information that other NFs can understand and vice versa.

### FIELD OF THE INVENTION

The present disclosure, generally, relates to a method and apparatus for multiple user equipment identifier translation in a wireless communication system. More particularly, the present disclosure relates to a method and apparatus for providing optimization in UE identified translation.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The 3rd Generation Partnership Project (3GPP) is a worldwide forum consisting of several standards organizations which develop protocols for mobile telecommunication. A standard telecommunication system following 3GPP standards consists of multiple components namely the User Equipment UE, base station and the 5G-CN. A UE registered to a 5G network shall be allocated a UE identifier for use within a 3GPP system.

The 5G Core Network (5G-CN) comprises various network functions (NFs) interacting with each other over a Service-Based Architecture (SBA) interface. Each NF has specific functionality and offers a set of services to other NFs. Among them, the Unified Data Repository (UDR) is responsible for storing all information related to User Equipment (UE) in a database. This storage information contains subscription data, exposure data, application data, and policy data. Another NF called the Unified Data Management (UDM) serves as the front-end interface to UDR for accessing the subscription data of the UE(s) from the database. UDM manages data for access authentication, access authorization, user registration, user identification handling and so on. Another important NF is Network Exposure Function (NEF) that acts as a gateway for an external untrusted application function (uAF) to avail services from 5G-CN after prior authorization and authentication based on operator policies. Apart from this, it is also responsible for translation of external information from uAF to internal information that other NFs can understand and vice versa. Any UE registered to a network is identified by a UE identifier which can be broadly classified into external identifier, like General Public Subscription Identifier (GPSI) and internal identifier that can be Subscription Permanent Identifier (SUPI). The NEF needs to contact the internal NFs in order to provide the information requested by uAF. In this regard, NEF translates external Identifiers to internal Identifiers using the subscription service of UDM and vice versa. In UDM, Nudm_Subscription DataManagement (Nudm_SDM_Get) Multiple Identifiers Translation service has the provision to translate multiple GPSIs to SUPIs. The present disclosure covers workable solutions that shall provide an optimization on the translation of multiple SUPIs to their corresponding GPSI(s).

### OBJECTS OF THE INVENTION

An objective of the present disclosure is to provide an optimized process for UE identifier translation in UDM that NF consumer, for example NEF, can utilize.

Another object of the present disclosure is to provide AF specific identifiers as query parameters and handle appropriate failure conditions.

### SUMMARY OF THE INVENTION

The summary is provided to introduce aspects related to a method for multiple user equipment identifier translation in a wireless communication system and the aspects are further described below in the detailed description. This summary is not intended to identify essential features of the claimed subject matter nor is it intended for use in determining or limiting the scope of the claimed subject matter.

According to one embodiment, the present disclosure provides a method for multiple User Equipment (UE) identifier translation in a wireless communication system, the method comprises: receiving, by a unified data management (UDM) function from a Network Function, a service request to support translation of at least one subscription permanent identifier (SUPI) of at least one UE to its corresponding at least one generic public subscription Identifier (GPSI), translating by the UDM, the at least one SUPI to the at least one GPSI sending, by the UDM, a response comprising a message body, wherein, the message body includes one of the at least one GPSI on successful translation, and the error code and an application error when at least one GPSI corresponding to any of the SUPIs are not found in the database.

According to another embodiment, the present disclosure provides determining by the UDM, selecting one of the at least one GPSI based on the at least one AF specific parameter when the at least one GPSI is allowed and the error response when the at least one GPSI is not allowed; sending, by the UDM, one of: the selected at least one GPSI or the error response.

According to one embodiment, the present disclosure provides receiving by the NEF, a request for a service from an application function (AF), to get an information about the plurality of UEs in an area; requesting by the NEF, the information from an AMF about the number of UEs in an area; receiving by the NEF from the AMF, the information about the plurality of UEs, wherein the information includes UE identifiers as SUPI(S); requesting by NEF, the UE Identifier Translation from a UDM, wherein the information includes the plurality of UE identifiers as SUPI(S) and AF specific parameter; receiving, by the NEF, one of: the single attribute containing the GPSI list from the UDM; and the error code; sending, by the NEF, one of; the single attribute containing the GPSI list and total number of UEs to the AF; and the error code.

In another embodiment of the invention, an apparatus for multiple User Equipment (UE) identifier translation by unified data management (UDM) in a wireless communication system, the apparatus comprising: one or more memories; and one or more processors coupled to the memories and adapted to: receive, by a unified data management (UDM) function from a Network Function, a service request to support translation of at least one subscription permanent identifier (SUPI) of at least one UE to its corresponding at least one Generic Public Subscription Identifier (GPSI), translate by the UDM, the at least one SUPI to the at least one GPSI send, by the UDM, a response comprising a message body, wherein, the message body includes one of the at least one GPSI on successful translation, and the error code and an application error when at least one GPSI corresponding to any of the SUPIs are not found in the database.

In another embodiment of the invention, the apparatus configured to: determine by the UDM, selecting one of: the at least one GPSI based on the at least one AF specific parameter when the at least one GPSI is allowed; and the error response when the at least one GPSI is not allowed; send, by the UDM, one of: the selected at least one GPSI or the error response.

In another embodiment of the invention, the apparatus configured to: receive by the NEF, a request for a service from an application function (AF), to get an information about the plurality of UEs in an area; request by the NEF, the information from an AMF about the number of UEs in an area; receive by the NEF from the AMF, the information about the plurality of UEs, wherein the information includes UE identifiers as SUPI(S); request by NEF, the UE Identifier Translation from a UDM, wherein the information includes the plurality of UE identifiers as SUPI(S) and AF specific parameter; receive, by the NEF, one of: the single attribute containing the GPSI list from the UDM; and the error code; send, by the NEF, one of; the single attribute containing the GPSI list and total number of UEs to the AF; and the error code.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates classification of UE identifiers.

FIG. 2 illustrates General End-to-End call flow for Event Monitoring request from uAF.

FIG. 3 illustrates Call Flow for Event Monitoring with multiple NEF-UDM transactions.

FIG. 4 illustrates Call-Flow for Event Monitoring with Nudm_SDM_Get Multiple Identifiers Translation.

FIG. 5 illustrates method for multiple User Equipment (UE) identifier translation by UDM in a wireless communication in accordance with an embodiment of the disclosure.

FIG. 6 illustrates method for multiple User Equipment (UE) identifier translation in a wireless communication in accordance with another embodiment of the disclosure.

FIG. 6A illustrates method for multiple User Equipment (UE) identifier translation by NEF in a wireless communication in accordance with an embodiment of the disclosure.

FIG. 7 illustrates Call-Flow between NF Service Consumer and UDM in accordance with an embodiment of the disclosure.

FIG. 8 illustrates a system for multiple User Equipment (UE) identifier translation in a wireless communication in accordance with an embodiment of the disclosure.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

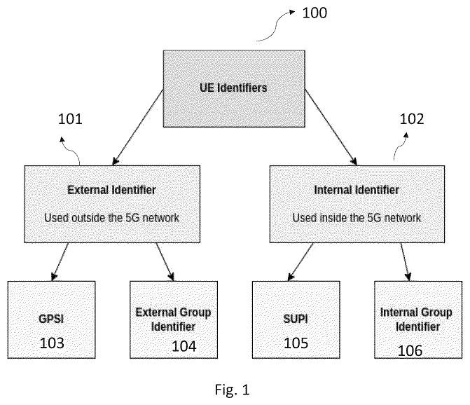

FIG. 1 illustrates the classification of UE identifiers (100). The UE Identifiers are broadly categorized into external identifiers (101) and internal identifiers (102). External identifiers are generally used by external entities like external untrusted application functions (uAF) that are outside a 5G network. Generic Public Subscription Identifier (GPSI) (103), being in public domain, is an external identifier and can be Mobile Station International Subscriber Directory Number (MSISDN). However, internal identifiers (102) are assigned and used only inside the 5G network. They cannot be exposed outside 5G Network for security reasons and to protect user confidentiality. Subscription permanent identifier (SUPI) (105) and internal group identifier (106) come under the category of internal identifiers. The 5G-CN maintains an association of both these identifiers in the subscriber database of UDR. Unified Data Management (UDM), being the front end for UDR, provides a service for the translation of the external identifier to internal identifier and vice-versa.

The NEF in 5G-CN acts as a gateway for a uAF by exposing appropriate information of UE(s) based on operator policies. It translates the request from a uAF and forwards it to the respective NF depending upon the type of service requested. Prior to obtaining services from the 5G Network, the uAF is authenticated and authorized by NEF.

If the untrusted application function (uAF) requests Network Exposure Function (NEF) for a specific service related to specific UE(s), NEF should contact the corresponding NF in 5G-CN to cater to uAF's request. The UE in the request identified by an external identifier that is, GPSI, is translated into an internal identifier that is, SUPI by NEF. The translation is required as internal NFs provide service based on internal identifiers only. Similarly, if the response to uAF contains internal identifiers, they need to be translated to external identifiers. The translation of external identifiers into internal identifiers and vice versa is provided as a service by the UDM using the Nudm_SDM_Get Identifier Translation service API.

NEF offers multiple services such as Traffic Influence, Event Monitoring, AFSession WithQoS and so on. One of the services is Event Monitoring. In this service, specific events of a UE such as UE Location, Number of UEs in Area, Communication Failure, PDU Session Status and so on are exposed. The uAF subscribes to NEF to receive response and notifications for the same.

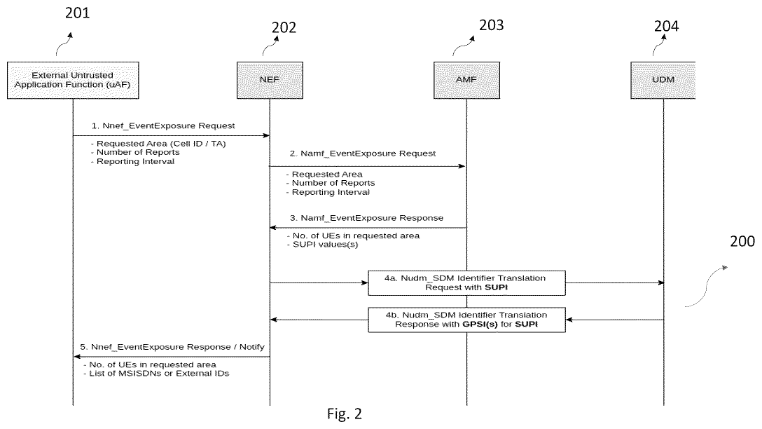

One such event that can be monitored and reported is “NUMBER_OF_UES_IN_AN_AREA” where the uAF can obtain information about the number of UEs in a specific geographical area. The granularity of the requested area can be a list of Cell Identities, or a list of Tracking Area identities, or list of Next Generation Radio Access Network (NG-RAN) nodes within a PLMN operator domain. As illustrated in FIG. 2, uAF (201) invokes the Nnef_EventExposure service of NEF (202) with event type as “NUMBER OF_UES_IN_AN AREA” for a specific area in step 1. The Access and Mobility Management Function (AMF) (203) is responsible for managing the UE mobility and will hence have the information about the number of UEs registered or present in a specific area. AMF offers this information using “UES_IN_AREA_REPORT” event in Namf_EventExposure service. In step 2, the NEF will subscribe using the Namf_EventExposure service of AMF. In step 3, in response to the subscription of NEF, AMF sends the total number of UEs in the requested area along with their identifiers, that is, SUPI(s). This information is provided by AMF to NEF through an immediate response or via an event notification for future event reports.

SUPI cannot not be exposed outside the 5G network. So, in step 4a and 4b the NEF queries the UDM using Nudm_SDM_Get Identifier Translation service API to obtain the GPSI(s) corresponding to a SUPI. If there are multiple GPSIs associated with a single SUPI, then UDM/UDR provides all the GPSIs during UE identifier translation to NEF. The NEF will select a single GPSI for a given SUPI, based on operator policies and/or available AF specific parameters, to send to the uAF. The total number of UEs and their Identifiers, that is, GPSI(s) will be sent to uAF by NEF in step 5 as a response or through event notifications.

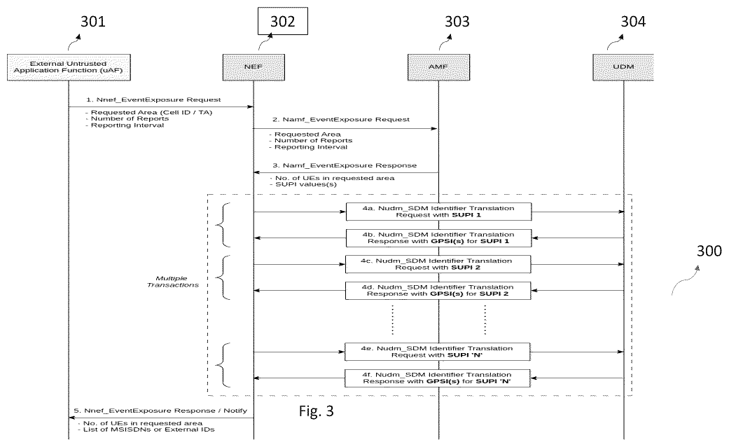

The NEF (302) receives the response or notification from the AMF (303) for the event “NUMBER OF UES_IN_AREA” with ‘N’ number of UEs along with their Identifiers that is SUPIs. FIG. 3 illustrates multiple repeated transactions between NEF and UDM (304) from step 4a to step 4f that are required to fetch the GPSI(s) for each SUPI provided by AMF in step 3. Hence, NEF has to query the UDM ‘N’ times using Nudm_SDM_Get Identifier Translation API. This is not an optimal way, as it involves multiple repeated transactions, thus making the process inefficient and increasing the system load level.

To reduce the multiple repeated interactions between NEF and UDM during translation of ‘N’ number of SUPIs to their corresponding GPSI(s) using Nudm_SDM_Get Identifier Translation, a solution is proposed to provide the list of SUPIs in a single request to fetch each SUPI's corresponding list of GPSIs in a single response. In an existing service of UDM namely Nudm_SDM_Get Multiple Identifiers Translation provides the conversion of list of GPSIs to fetch each GPSI's corresponding list of SUPI(s) through a single API request. In the same API, it is proposed to support the translation of list of SUPIs to their corresponding GPSI(s).

TABLE 1

| Name | Data type | P | Cardinality | Description |
|---|---|---|---|---|
| gpsi-list | array(Gpsi) | C | 1 . . . N | List of GPSIs. |
| | | | | Shall be present if supi- |
| | | | | list is not present |
| supi-list | array(Supi) | C | 1 . . . N | List of SUPIs. |

NOTE:
The attributes “gpsi-list” and “supi-list” are mutually exclusive.

The above mentioned table is a part of the query parameters in the Nudm_SDM_Get Multiple Identifiers Translation service API request. An attribute “gpsi-list” is already present containing the list of GPSIs. This shall be a conditional or optional parameter. In the proposed solution, a new attribute shall be introduced in the request table sent by an NF service consumer to UDM. The new attribute shall contain a list of SUPIs as part of the query parameters. The new attribute shall be a conditional or optional parameter with an array datatype in the Nudm_SDM_Get Multiple Identifiers Translation service API request. As mentioned in Table 1, the name of the new attribute shall be “supi-list”.

TABLE 2

| Attribute name | Data type | P | Cardinality | Description |
|---|---|---|---|---|
| ueIdList | map(SupiInfo) | C | 1 . . . N | A map with list of key-value pairs |
| | | | | where Gpsi serves as key and value |
| | | | | containing arrays of Supi. |
| ueIdGpsiList | map(GpsiInformation) | C | 1 . . . N | A map with list of key-value pairs |
| | | | | where Supi serves as key and value |
| | | | | containing arrays of Gpsi. |
| | | | | The element in the attribute contains |
| | | | | only the GPSIs determined based on |
| | | | | the query parameters. |

A new attribute is also proposed to be added in the response ie., message body sent by UDM to NF service consumer. The new attribute shall be a conditional parameter. The new attribute shall have a map datatype. This also shall contain a mapping association between two UE identifiers, an internal and external identifier. This shall be included in the Nudm_SDM_Get Multiple Identifiers Translation response from UDM to NF service consumer, that is, NEF. As mentioned in Table 2, the key to the map shall contain the SUPI already obtained in the NEF request to UDM while the value shall contain the corresponding GPSI(s). The map's key shall be defined as a string data type. The map attribute name shall be “ueIdGpsiList”.

TABLE 3

| Name | Data Type | P | Cardinality | Description |
|---|---|---|---|---|
| gpsiList | array (Gpsi) | M | 0 . . . N | This IE shall indicate a list of GPSIs that |
| | | | | are associated with the Supi. |
| | | | | An empty array shall be returned if there |
| | | | | are no GPSIs associated with the Supi. |

The map's value shall have a new attribute containing the GPSI(s). This attribute shall be a mandatory parameter. The map's value shall be defined as an array of strings. As mentioned in Table 3, the name of the new attribute shall be “gpsiList”. If there are multiple GPSIs corresponding to a single SUPI, UDM sends all the possible GPSIs. The NEF based on operator policies and/or available AF specific parameters shall choose a GPSI and sends it to uAF through Nnef_EventExposure Monitoring Event API response or via an event notification.

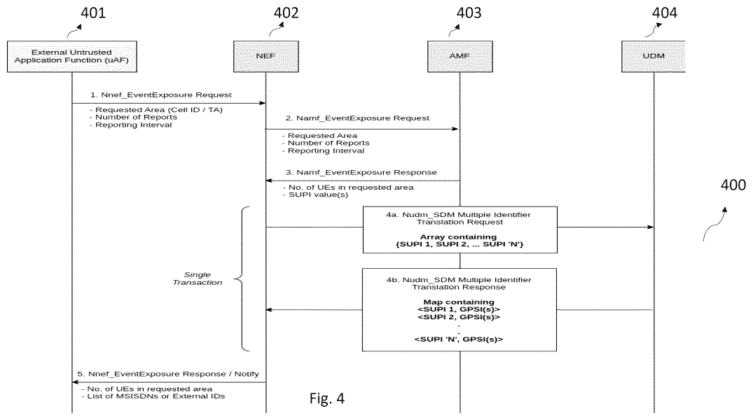

The present disclosure provides an optimized method to make the UE identifier translation process more efficient by reducing the number of transactions that take place between NEF and UDM. According to another embodiment of the invention, FIG. 4 illustrates a modified call flow for an event monitoring request by a uAF (401) for the event “NUMBER_OF_UES_IN_AN_AREA”. In this, when NEF (402) obtains a list of SUPIs from AMF (403) in step 3 for the area requested by uAF, NEF needs to translate the internal identifiers to external identifiers. In step 4a and 4b, NEF invokes Nudm_SDM_Get Multiple Identifiers Translation service API to translate the list of SUPIs into its respective GPSI(s) in a single transaction. Hence, the number of transactions between NEF and UDM (404) for UE identifier translation is optimized. Further, the NEF provides the obtained external identifier(s) to the uAF. The support provided in Nudm_SDM_Get Multiple Identifiers Translation service API of UDM shall enable the NEF to translate multiple SUPIs to its respective GPSI(s) in a single transaction. This helps to make the UE identifier translation process more efficient.

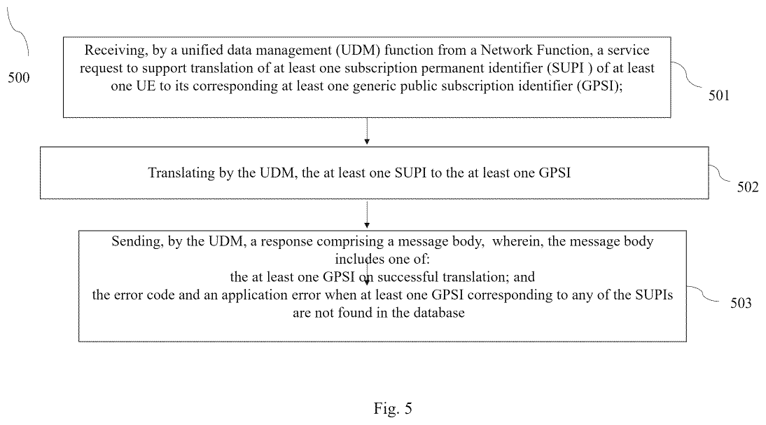

According to another embodiment of the invention, FIG. 5 illustrates a method for multiple User Equipment (UE) identifier translation by unified data management (UDM) in a wireless communication system. The method (500) involves the following steps At Step 1, receiving (501), by a unified data management (UDM) function from a Network Function, a service request to support translation of at least one subscription permanent identifier (SUPI) of at least one UE to its corresponding at least one Generic Public Subscription Identifier (GPSI). At Step 2, translating (502) by the UDM, the at least one SUPI to the at least one GPSI. At Step 3, sending (503), by the UDM, a response comprising a message body, wherein, the message body includes one of: the at least one GPSI on successful translation, and the error code and an application error when at least one GPSI corresponding to any of the SUPIs are not found in the database.

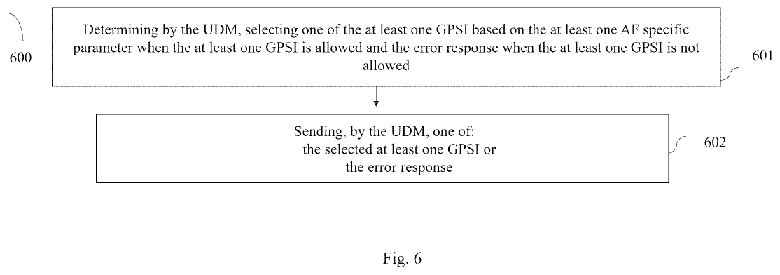

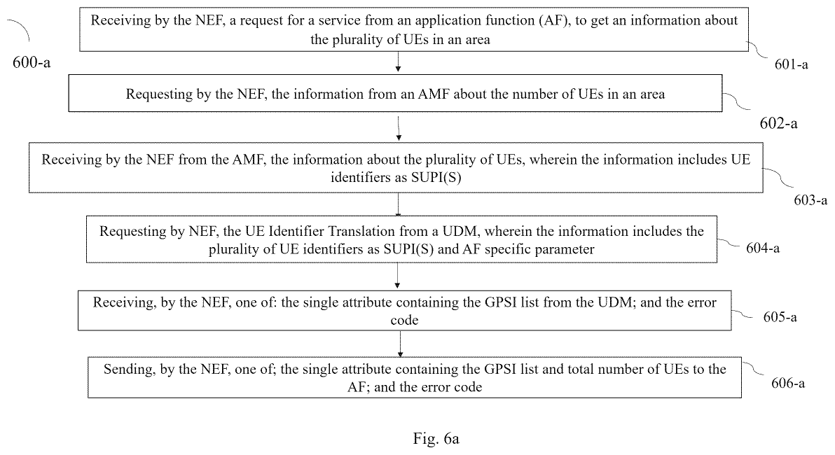

According to another embodiment of the invention, FIG. 6 illustrates the method that involves the following steps: At Step 1, determining (601) by the UDM, selecting one of: the at least one GPSI based on the at least one AF specific parameter when the at least one GPSI is allowed; and the error response when the at least one GPSI is not allowed; At Step 2, sending (602), by the UDM, one of: the selected at least one GPSI or the error response.

TABLE 4

| Name | Data type | P | Cardinality | Description |
|---|---|---|---|---|
| gpsi-list | array(Gpsi) | C | 1 . . . N | List of GPSIs. |
| | | | | Shall be present if supi-list is not |
| | | | | present |
| supi-list | array(Supi) | C | 1 . . . N | List of SUPIs. |
| af-id | string | O | 0 . . . 1 | AF Identifier. |
| | | | | If not present, additional authorization |
| | | | | on AF identifier is not required. |
| app-port- | AppPortId | C | 0 . . . 1 | Indicates the Application port identity. |
| id | | | | This attribute shall be present if supi- |
| | | | | list is present in the query parameters |
| | | | | and if the application port identity is |
| | | | | available. |
| af- | string | C | 0 . . . 1 | Indicates the Application Service |
| service-id | | | | Identifier. |
| | | | | This attribute shall be present if supi- |
| | | | | list is present in the query parameters |
| | | | | and if the application service identifier |
| | | | | is available. |
| mtc- | MtcProviderInformation | C | 0 . . . 1 | Indicates the information of MTC |
| provider- | | | | Service Provider and/or MTC |
| info | | | | Application. |
| | | | | This attribute shall be present if supi- |
| | | | | list is present in the query parameters |
| | | | | and if the MTC provider information is |
| | | | | available. |
| requested- | GpsiType | C | 0 . . . 1 | Indicates the requested GPSI type, and |
| gpsi-type | | | | it may be included when the query |
| | | | | parameters has supi-list. |

The AF-specific parameters as mentioned in Table 4 are utilized by the UDM to filter GPSI based on the requested AF corresponding to the SUPI. These parameters include af-id (AF Identifier), app-port-id (Application Port Identifier), af-service-id (Application Service Identifier), mtc-provider-info (MTC Provider Information), and requested-gpsi-type (Requested GPSI Type).
af-id attribute filters GPSI based on the AF identifier.
app-port-id attribute helps identify GPSI for traffic flows associated with specific applications running on a that particular port.
af-service-id attribute helps distinguish GPSI by managing and differentiating various application services.
mtc-provider-info attribute maps GPSI to a specific Machine-Type Communication (MTC) Service Provider and/or MTC Application.
requested-gpsi-type attribute specifies the type of GPSI being requested.

According to another embodiment of the invention, FIG. 6A illustrates a method for multiple User Equipment (UE) identifier translation by network exposure function (NEF) in a wireless communication system. The method (600a) involves the following steps: At Step 1,receiving (601-a) by the NEF, a request for a service from an application function (AF), to get an information about the plurality of UEs in an area. At Step 2, requesting (602-a) by the NEF, the information from an AMF about the number of UEs in an area. At Step 3, receiving (603-a) by the NEF from the AMF, the information about the plurality of UEs, wherein the information includes UE identifiers as SUPI(S). At Step 4, requesting (604-a) by NEF, the UE Identifier Translation from a UDM, wherein the information includes the plurality of UE identifiers as SUPI(S) and AF specific parameter. At Step 5, receiving (605-a), by the NEF, one of: the single attribute containing the GPSI list from the UDM; and the error code. At Step 6 sending (606-a), by the NEF, one of; the single attribute containing the GPSI list and total number of UEs to the AF; and the error code.

TABLE 5

| | | | Response | |
|---|---|---|---|---|
| Data type | P | Cardinality | codes | Description |
| UeIdentifiers | M | 1 | 200 OK | Upon success, a response body containing the |
| | | | | list of UE identifier(s) shall be returned. |
| ProblemDetails | O | 0 . . . 1 | 404 Not | The “cause” attribute may be used to indicate |
| | | | Found | one of the following application errors: |
| | | | | USER_NOT_FOUND |
| | | | | DATA_NOT_FOUND |
| ProblemDetails | O | 0 .. 1 | 403 | The “cause” attribute may be used to indicate |
| | | | Forbidden | one of the following application errors: |
| | | | | AF_NOT_ALLOWED |
| | | | | MTC_PROVIDER_NOT_ALLOWED |

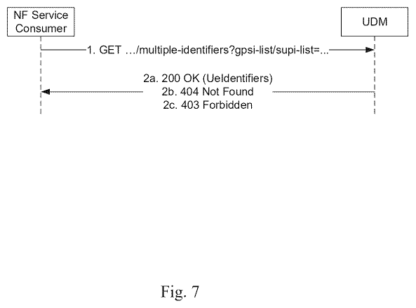

According to another embodiment of the invention, FIG. 7 illustrates that the NF service consumer (e.g TSCTSF, NEF) sends a request to the UDM to receive the list of the UE identifiers (i.e. SUPIs/GPSIs) that corresponds to the provided UE identifiers (i.e. GPSIs/SUPIs). The NF Service Consumer (e.g. TSCTSF, NEF) shall send a GET request to the resource representing the list of GPSIs/SUPIs handled by UDM; the list of GPSIs/SUPIs are passed in a query parameter of the request URI and/or necessary information used for identifier translation e.g. af-id, app-port-id, etc. On success, as mentioned in above Table 5, the UDM shall respond with “200 OK” with the message body containing the list of UE Identifiers with list of SUPIs/GPSIs that belong to each provided GPSI/SUPI. If the expected result of multiple identifier translation is GPSIs and the AF specific query parameters (e.g. af-id, app-port-id, af-service-id, mtc-provider-info, etc) are provided, the UDM shall take the provided AF specific information into account to determine the GPSI to be returned for each UE in the supi-list. The AF specific GPSI may be an MSISDN or an External Identifier. If there is no valid data for any of the UEs for the given list of SUPIs, HTTP status code “404 Not Found” shall be returned including additional error information in the response body (in the “ProblemDetails” element). If the AF identified by the AF specific parameters in the query, is not allowed to perform this operation for any of the UEs in the list, HTTP status code “403 Forbidden” shall be returned including additional error information in the response body (in the “ProblemDetails” element). On failure, the appropriate HTTP status code indicating the error shall be returned and appropriate additional application error information should be returned in the GET response body.

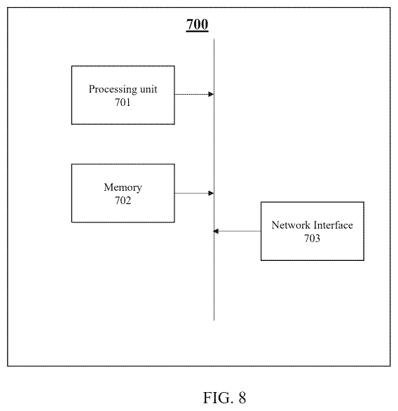

In yet another embodiment of the invention, FIG. 8 illustrates an example architecture of a system 700 of a network, in accordance with various embodiments. The following description is provided for an example system that operates in conjunction with the LTE system standards and 5G or NR system standards as provided by 3GPP technical specifications. However, the example embodiments are not limited in this regard and the described embodiments may apply to other networks that benefit from the principles described herein, such as future 3GPP systems (e.g., Sixth Generation (6G)) systems, IEEE 802.16 protocols (e.g., WLAN, WiMAX, etc.), or the like.

In an example, the transmitter/receiver 700 includes a processing unit 701 that may be a single processing unit or a number of units, all of which could include multiple computing units. The processing unit 701 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processing unit 701 is configured to fetch and execute computer-readable instructions and data stored in the memory 702.

The memory 702 may include any non-transitory computer-readable medium known in the art including, for example, volatile memory, such as static random-access memory (SRAM) and dynamic random access memory (DRAM), and/or non-volatile memory, such as read-only memory (ROM), erasable programmable ROM, flash memories, hard disks, optical disks, and magnetic tapes.

As a further example, the processing unit 701 coupled with memory may be configured to implement the method as explained in FIGS. 5, 5a & 6. The hardware may include a hardware disk controller with programmable search capabilities or a software system running on general-purpose hardware. Examples of databases but are not limited to, in-memory databases, cloud databases, distributed databases, embedded databases, and the like. The database amongst other things, serves as a repository for storing data processed, received, and generated by one or more of the processor(s).

As a further example, the network interface 703 is configured to provide and establish communication with any electronic device via a public network, private network, or any wireless communication technology.

The figures of the disclosure are provided to illustrate some examples of the invention described. The figures are not to limit the scope of the depicted embodiments of the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a scripting language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise. In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

We claim:

1. A method (500) for multiple user equipment (UE) identifier translation in a wireless communication system, the method comprises:
receiving (501), by a unified data management (UDM) function from a Network Function, a service request to support translation of at least one subscription permanent identifier (SUPI) of at least one UE to its corresponding at least one generic public subscription identifier (GPSI);
translating (502) by the UDM, the at least one SUPI to the at least one GPSI; and
sending (503), by the UDM, a response comprising a message body, wherein, the message body includes one of:
the at least one GPSI on a successful translation; and
the error code and an application error when at least one GPSI corresponding to any of the SUPIs are not found in the database.

2. The method as claimed in claim 1, wherein the service is “Nudm_SDM_get multiple identifiers translation”.

3. The method as claimed in claim 1, wherein the Network Function is one of network exposure function (NEF), access and mobility management function (AMF), session management function (SMF), short message service function (SMSF), gateway mobile location centre (GMLC), network data analytics function (NWDAF), data collection coordination function (DCCF), trusted AF, location management function (LMF).

4. The method as claimed in claim 1, wherein the SUPI is an internal identifier and GPSI is an external identifier of the UE.

5. The method as claimed in claim 1, wherein the request to support translation of SUPI(s) comprises of at least one query parameter.

6. The method as claimed in claim 5, wherein the at least one query parameter comprising plurality of at least one of application function (AF) specific parameter and SUPI.

7. The method as claimed in claim 6, wherein the query parameter is in plurality of attributes; wherein the plurality of attributes comprise “supi-list”.

8. The method as claimed in claim 1, wherein the at least one GPSI is provided using the attribute “ueIdGpsilist”.

9. The method as claimed in claim 8, wherein the attribute “ueIdGpsilist” is of a map data type, wherein the map data type comprises the mapping association between two UE identifiers.

10. The method as claimed in claim 9, wherein the map data type comprises a map's key and plurality of map's value.

11. The method as claimed in claim 10, wherein the map's key is defined as string data type representing the SUPI.

12. The method as claimed in claim 10, wherein the map's value comprises all possible GPSIs corresponding to every SUPI.

13. The method as claimed in claim 1, wherein, on the successful translation, the UDM shall respond with “200 OK”.

14. The method as claimed in claim 1, wherein, on the error code will be “404 Not Found”.

15. The method as claimed in claim 1, further comprising:
determining (601) by the UDM, selecting one of:
the at least one GPSI based on the at least one AF specific parameter when the at least one GPSI is allowed; and
the error response when the at least one GPSI is not allowed;
sending (602), by the UDM, one of:
the selected at least one GPSI or the error response.

16. The method as claimed in claim 6, wherein the AF specific parameter is at least one of AF Identifier, Application Port Identifier, Application Service Identifier, MTC Provider Information and Type of GPSI.

17. The method as claimed in claim 15 and claim 16, wherein the error response comprises an error code “403 Forbidden” and an application error “AF_NOT_ALLOWED” when the at least one AF specific parameter is the AF Identifier.

18. The method as claimed in claim 15 and claim 16, wherein the error response comprises an error code “403 Forbidden” and an application error “MTC_PROVIDER_NOT_ALLOWED” when the at least one AF specific parameter is the MTC Provider Information.

19. The method (600-a) as claimed in claim 1, further comprising:
receiving (601-a) by the NEF, a request for a service from an application function (AF), to get an information about the plurality of UEs in an area;
requesting (602-a) by the NEF, the information from an AMF about the number of UEs in an area;
receiving (603-a) by the NEF from the AMF, the information about the plurality of UEs, wherein the information includes UE identifiers as SUPI(S);
requesting (604-a) by NEF, the UE Identifier Translation from a UDM, wherein the information includes the plurality of UE identifiers as SUPI(S) and AF specific parameter;
receiving (605-a), by the NEF, one of:
the single attribute containing the GPSI list from the UDM; and
the error code;
sending (606-a), by the NEF, one of;
the single attribute containing the GPSI list and total number of UEs to the AF; and
the error code.

20. An apparatus for multiple User Equipment (UE) identifier translation in a wireless communication system, the apparatus comprising:
one or more memories; and
one or more processors coupled to the memories and adapted to:
receive, by a unified data management (UDM) function from a Network Function, a service request to support translation of at least one subscription permanent identifier (SUPI) of at least one UE to its corresponding at least one Generic Public Subscription Identifier (GPSI),
translate by the UDM, the at least one SUPI to the at least one GPSI send, by the UDM, a response comprising a message body, wherein, the message body includes one of
the at least one GPSI on successful translation, and
the error code and an application error when at least one GPSI corresponding to any of the SUPIs are not found in the database.

21. The apparatus as claimed in claim 20, wherein the service is “Nudm_SDM get multiple identifiers translation”.

22. The apparatus as claimed in claim 20, wherein the Network Function is one of network exposure function (NEF), access and mobility management function (AMF), session management function (SMF), short message service function (SMSF), gateway mobile location centre (GMLC), network data analytics function (NWDAF), data collection coordination function (DCCF), trusted AF, location management function (LMF).

23. The apparatus as claimed in claim 20, wherein the SUPI is an internal identifier and GPSI is an external identifier of the UE.

24. The apparatus as claimed in claim 20, wherein the request to support translation of SUPI(s) comprises of at least one query parameter.

25. The apparatus as claimed in claim 24, wherein the at least one query parameter comprising plurality of at least one of application function (AF) specific parameter and SUPI.

26. The apparatus as claimed in claim 25, wherein the query parameter is in plurality of attributes; wherein the plurality of attributes comprise “supi-list”.

27. The apparatus as claimed in claim 20, wherein at least one the GPSI is provided using the attribute “ueIdGpsilist”.

28. The apparatus as claimed in claim 27, wherein the attribute “ueIdGpsilist” is of a map data type, wherein the map data type comprises the mapping association between two UE identifiers.

29. The apparatus as claimed in claim 28, wherein the map data type comprises a map's key and plurality of map's value.

30. The apparatus as claimed in claim 29, wherein the map's key is defined as string data type representing the SUPI.

31. The apparatus as claimed in claim 29, wherein the map's value comprises all possible GPSIs corresponding to every SUPI.

32. The apparatus as claimed in claim 20, wherein, on the successful translation, the UDM shall respond with “200 OK”.

33. The apparatus as claimed in claim 20, wherein, on the error code will be “404 Not Found”.

34. The apparatus as claimed in claim 20, further configured to:
determine by the UDM, selecting one of:
the at least one GPSI based on the at least one AF specific parameter when the at least one GPSI is allowed; and
the error response when the at least one GPSI is not allowed;
send, by the UDM, one of:
the selected at least one GPSI or the error response.

35. The apparatus as claimed in claim 25, wherein the AF specific parameter is atleast one of AF Identifier, Application Port Identifier, Application Service Identifier, MTC Provider Information and Type of GPSI.

36. The apparatus as claimed in claim 34 and claim 35, wherein the error response comprises an error code “403 Forbidden” and an application error “AF_NOT_ALLOWED” when the at least one AF specific parameter is the AF Identifier.

37. The apparatus as claimed in claim 34 and claim 35, wherein the error response comprises an error code “403 Forbidden” and an application error “MTC_PROVIDER_NOT_ALLOWED” when the at least one AF specific parameter is the MTC Provider Information.

38. The apparatus as claimed in claim 20, further configured to:
receive by the NEF, a request for a service from an application function (AF), to get an information about the plurality of UEs in an area;
request by the NEF, the information from an AMF about the number of UEs in an area;
receive by the NEF from the AMF, the information about the plurality of UEs, wherein the information includes UE identifiers as SUPI(S);
request by NEF, the UE Identifier Translation from a UDM, wherein the information includes the plurality of UE identifiers as SUPI(S) and AF specific parameter;
receive, by the NEF, one of:
the single attribute containing the GPSI list from the UDM; and
the error code;
send, by the NEF, one of;
the single attribute containing the GPSI list and total number of UEs to the AF; and
the error code.
